(19) United States
(12) Patent Application Publication
(10) Pub. No.: US 2004/0192429 A1
(43) Pub. Date: Sep. 30, 2004

(54) Method of operating a gaming machine with a ticket printer

(76) Inventor: Ernest W. Moody, Las Vegas, NV (US)

Correspondence Address: JOHN EDWARD ROETHEL, 2290 S. JONES BLVD. #100, LAS VEGAS, NV, 89146, US

(21) Appl. No.: 10/818,983

(22) Filed: Apr. 5, 2004

Related U.S. Application Data
(63) Continuation of application No. 10/038,929, filed on Jan. 3, 2002, now abandoned.
(60) Provisional application No. 60/259,999, filed on Jan. 5, 2001.

(51) Int. Cl. A63F 13/00

(52) U.S. Cl. 463/16

(57) ABSTRACT

Whenever a player achieves a predetermined combination of playing cards or slot symbols on a gaming machine or on a random basis determined by the gaming machine, the ticket printer on the gaming machine would print out for the player a keno ticket, a lottery ticket, a sweepstakes ticket, an entry into a prize contest, a redeemable coupon or other valuable printed award. Alternatively, the gaming machine could be configured to have real time access to the world wide web. The player can then redeem his prize award from a group of prizes that can be displayed to the player.

### CROSS-REFERENCE TO RELATED APPLICATION

This application is a Continuation of application Ser. No. 10/038,929, filed Jan. 3, 2002, entitled “Method of Operating a Gaming machine with a Ticket Printer” and is also based on Provisional Application, Serial No. 60/259,999, filed Jan. 5, 2001, entitled “Method of Operating a Gaming machine with a Ticket Printer.”

This application relates to a method of operating a gaming machine with a printer and more particularly to a method of operating a gaming machine with a printer that presents to the player a keno ticket, a lottery ticket, a sweepstakes ticket, an entry into a prize contest, a redeemable coupon or other valuable printed award whenever the player achieves a predetermined outcome on the gaming machine or as a random occurrence. Alternatively, whenever the player achieves a predetermined outcome on the gaming machine or as a random occurrence, the player can be connected through the gaming machine to the world wide web to a web site at which place the player may select from an award shown to the player on the web site.

### BACKGROUND OF THE INVENTION

In the typical gaming casino, there are many types of gaming machines which generally fall into the categories of slot machines, video poker machines, video keno machines and other assorted mechanical or electronic gaming machines. Each of these games works on the general principle of the player making a wager to play the gaming machine, the player activating the gaming machine and the gaming machine displaying to the player the outcome of the game displayed on the gaming machine.

Some of the gaming machines are simply games of chance such as a slot machine. When playing the typical slot machine, the player first makes a wager and then the player activates the slot machine by pulling a handle or pressing a button. The reels of the slot machine spin and, when the reels stop spinning, the outcome is displayed to the player. Winning combinations result in a payout to the player based on the amount of the player's wager.

Another game of chance is a video keno machine. The player makes a wager, selects one or more numbers from a display of typically eighty numbers and presses a button to activate the play of the video keno machine. The computer controls of the keno machine select a group of numbers, typically twenty, and the player receives an award whenever some or all of the numbers selected by the player match the numbers selected by the computer controls.

Another game of chance is video draw poker. After making a wager, the player is dealt five cards face up. The player selects which cards, if any, the player wishes to hold, the unheld cards are discarded and replacement cards are dealt for the discarded cards. The final five card hand is analyzed to determine its poker hand ranking and the player is paid for winning poker hand rankings based on the amount of the player's wager. A pay table is displayed to the player showing the amounts that the player can win based on the poker hand ranking achieved by the player and the amount wagered by the player.

There are also other electronic casino gaming machines that have been introduced into gaming casinos in recent years that use “secondary events” to provide additional payouts to the player. In a typical secondary event game, the player first achieves some outcome on the first screen or level of the electronic gaming machine. This first level outcome that occurs during the play of the basic electronic casino game qualifies the player to play a secondary event where the player engages in another chance event to determined the amount to be won by the player.

One of the most popular secondary event games was “Wheel of Gold” marketed by Anchor Gaming Company. This game used a three reel slot machine as the first event. If the player lined up a “Spin” symbol on the pay line of the third reel, this qualified the player to go on to the secondary event. In the secondary event in “Wheel of Gold”, a rotating wheel similar to a Big Six Wheel is spun by the player who then receives the payout shown on the pay line when the wheel stops rotating.

Other secondary event games have followed. On the ODYSSEY multi-game machine marketed by Silicon Gaming Company, there is a secondary event game known as “Fort Knox” used in connection with a reel slot machine game. Each time the player spins the reels of the slot machine, a random number between 0 and 9 is selected. The random number selected is compared to a pre-established ten digit “code number” and when the player has successfully matched all ten digits of the code number, the player is taken to a secondary event screen in which the player selects one of three doors behind which is a payout amount awarded to the player.

Secondary event games have been added to video poker games also. In a game known as “Million Coin Scratch Poker” marketed by Boyd Gaming Group, the primary event game is a standard video draw poker game. Whenever the player achieves a flush in the primary event video poker game, the player is paid for achieving a flush and then is taken to a second screen in which the secondary event game is displayed. The secondary event game involves the player selecting five cards from a fifty-two card face down display, in effect, the player is playing a hand of five card stud poker. The player wins payouts depending on whether the player achieves particular poker hands during this secondary event game of five card stud poker.

Over the years, gaming establishments have also run promotions that encourage casino play. It is known to award the player special prizes, in addition to the regular gaming machine payout, whenever the player achieves certain winning combinations during the play of the gaming machine. For example, casinos have been known to award the player a warm-up jacket with the casino's logo whenever the player achieves a Royal Flush while playing video poker, in addition to the regular monetary award. Gaming establishments have also awarded players with entries into a raffle or drawing for prizes. Players earn a raffle or drawing ticket each time the player achieves a certain size win on a gaming machine, such as a $25 win whenever a player is playing a 25¢ gaming machine. The players fill out the raffle or drawing ticket and periodically, such as once each day, a ticket is drawn and the lucky player wins a new car.

Many gaming establishment operate “player's clubs” and issue ID cards to the players. Each gaming machine in the establishment is outfitted with player tracking electronics and the player inserts his ID card into a slot provided in the gaming machine. The gaming machine computer controls then track the wagering activity of the player and the player accumulates points to his player account based on the amount wagered by the player or the amount won by the player during the play of the gaming machine. The points accumulated by the player are redeemable for cash or prizes offered at the award center and can even be redeemed for meals and room charges at the gaming establishment.

None of the known electronic gaming machines interact in any way with any of the live casino games that are played in the gaming casino and that are available for play by gaming customers in the jurisdiction of the gaming casino. Many gaming casinos offer live keno games and many gaming casinos are located in gaming jurisdictions that also have state-run lotteries. There is a need in the casino gaming business for new and creative electronic casino games to capture the interest of the gaming patron and stimulate additional casino play.

None of the known gaming machines interact with the world wide web in any way and one of the ways that can be used to attract and keep players for gaming machines would be to have each gaming machine interact with the world wide web on a real time basis.

It is an object of the present invention to provide an interaction between the electronic gaming machines and other forms of wagering that may be available to the gaming patron in the jurisdiction of the gaming casino.

It is a further object of the present invention to utilize the electronic gaming machine to dispense awards to the player in the form of a keno ticket, a lottery ticket, a sweepstakes ticket, an entry into a prize contest, a redeemable coupon or other valuable printed award.

It is a further object of the present invention to utilize the electronic gaming machine to provide a real time connection to the world wide web while the player is playing the gaming machine.

It is a feature of the present invention to provide an electronic gaming machine that also includes a printer device which would print out and make available to the player a keno ticket or a lottery ticket that rewards the player with a entry into a live keno game or a lottery drawing. The player would receive the keno ticket or lottery ticket whenever the player achieves a predetermined combination of playing cards, keno number, slot symbols or the like during the play of the electronic gaming machine or on a random basis determined by the gaming machine. It is anticipated that the award of the keno ticket or lottery ticket would be in addition to any other award the player may have won on the electronic gaming machine.

It is a further feature of the present invention to provide an electronic gaming machine that also includes a printer device which would print out and make available to the player a sweepstakes ticket, an entry into a prize contest, a redeemable coupon or other valuable printed award that can be redeemed by the player at the gaming establishment.

It is a further feature of the present invention to provide an electronic gaming machine with real time world wide web access so that the player can redeem any awards that the player earned while playing the gaming machine. The gaming machine could access the world wide web in any suitable manner, such as by telephone line, cable modem or satellite. Prize award sites on the world wide web could be accessed by the player and the player could select his award from the prize award site while still sitting at the gaming machine.

It is an advantage of the present invention that the player will receive the opportunity to participate in a live keno game or a lottery game while at the same time the player is playing an electronic gaming machine. This will encourage the play of both the electronic gaming machines and the live keno games or lottery games and thus blend together the customers who normally play electronic gaming machines with live keno games and lottery games.

It is a further advantage of the present invention that the player can instantly receive, during the play of the gaming machine and from a printer mounted in the gaming machine, a sweepstakes ticket, an entry into a prize contest, a redeemable coupon or other valuable printed award without having to wait for the casino personnel to come by and make such an award to the player.

It is a further advantage of the present invention that the player can instantly redeem any prize award that the player has earned during the play of the gaming machine and a very large prize pool could be used, not limited to the storage space available on site at the gaming casino.

Other objects, features and advantages of the present invention will become apparent from a consideration of the following detailed description.

### SUMMARY OF THE INVENTION

The present invention comprises the method of operating a gaming machine to include the award of a keno ticket or lottery ticket when the player achieves a predetermined combination of playing cards or slot symbols on the gaming machine or on a random basis determined by the gaming machine. In the method of operation, the player plays a video poker gaming machine or a slot machine in the conventional manner. During the play of the gaming machine, the player may achieve certain predetermined combinations of playing cards (during the play of video poker) or slot symbols (during the play of a slot machine). When the player achieves such a combination, the computer controls of the gaming machine will cause a printer located in the gaming machine to print out a keno ticket or a lottery ticket which would then allow the participate in an upcoming live keno game or lottery drawing. Alternatively, the printer would print out for the player a sweepstakes ticket, an entry into a prize contest, a redeemable coupon or other valuable printed award.

In the preferred embodiment of the present invention, the player would receive the keno ticket, the lottery ticket, the sweepstakes ticket, an entry into a prize contest, a redeemable coupon or other valuable printed award in addition to any award that the player would have been entitled for achieving the combination of playing cards or slot symbols.

In another preferred embodiment of the present invention, the gaming machine could be configured to have real time access to the world wide web. Whenever the player earns a prize award from playing the gaming machine, the player could access a variety of gaming award sites located on the world wide web while the player is still seated at the gaming machine. The player can then redeem his prize award from a large group of prizes that can be displayed to the player on the video screen of the gaming machine.

### BRIEF DESCRIPTION OF THE DRAWINGS

FIG. 1 shows a gaming machine configured to operate the method of the present invention.

### DETAILED DESCRIPTION OF THE PREFERRED EMBODIMENTS

The method of operation of the gaming machine of the present invention commences with a player making a wager and playing a conventional electronic gaming machine. Any suitable electronic gaming machine can be used for the play of this basic game, such as a video poker machine or a slot machine. During the play of the gaming machine, the player will achieve winning and losing occurrences as is conventional. The player will be paid for winning occurrences and lose his wager for losing occurrences as is conventional.

Also, during the play of the video slot machine, the player will achieve certain combinations of playing cards or slot symbols that will award the player with an additional payout of a keno ticket or a lottery ticket. For example, the player could achieve a combination of symbols on a pay line of the video slot machine for which the player wins a “Keno Ticket” or a “Lottery Ticket”. In one embodiment, the player could line up three “ticket” symbols which would earn the player such a prize award. Alternatively, the award of the keno ticket or the lottery ticket could be as an additional award to a large jackpot for achieving “Three 7's”. Any suitable combination of symbols could be used. Alternatively, the player could simply be presented with a prize award on a random basis during the play of the gaming machine, regardless of whether the player has won or lost on a particular play of the game.

In another embodiment of the present invention, the player could be playing video poker. Whenever the player achieved a predetermined arrangement of playing cards, the player would be awarded with a keno ticket or a lottery ticket. For example, the player could win such a ticket for achieving a Royal Flush and the ticket would be awarded in addition to whatever payout the player would be entitled for the Royal Flush. Alternatively, the player could be awarded a keno ticket or a lottery ticket for being dealt a particularly poor starting hand, such as five cards with nothing higher than a Ten (with no pairs and not a Straight or a Flush). The player could be awarded such a ticket as a consolation award for having such a poor hand. Again the player could win a prize award on a random basis having nothing to with the outcome of the video poker game.

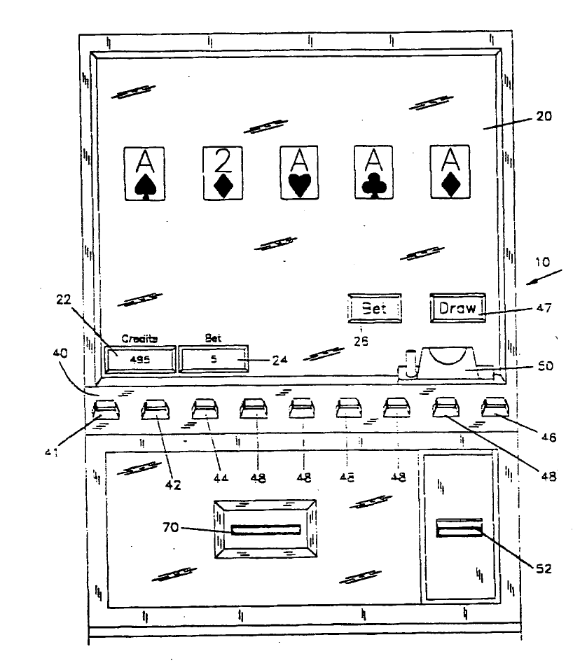

FIG. 1 shows generally at 10 a gaming machine upon which the method of the present invention can be carried out. The gaming machine 10 includes a video screen display 20 on which are shown the playing cards that will be used during the play of the method of the present invention. The video screen display 20 also includes other information and data presented to the player to allow the player to understand the play of the game and to effect the operation of the method.

In the preferred embodiment of the present invention, the video screen display 20 also shows a credit meter 22 and a first display 24 of the number of credits bet by the player. The video screen display also has touch screen locations to allow the player to DRAW 47 replacement cards and to make his BET 26. Each of the card locations on the video screen display can also be touch screen locations so that the player may designate which cards he wishes to hold by merely touching the card location on the video screen display 20.

The gaming machine 10 also has a button panel 40 which includes typical buttons that the player may press to activate various actions during the play of the method of the present invention. A CASH OUT button 41 is provided to allow the player to collect any credits which the player has accrued on the credit meter 22. A BET MAX button 42 and a BET ONE button 44 are provided to allow the player to wager either the maximum amount of credits permitted by the gaming machine or to wager one credit at a time on the play of the game as desired by the player. A DRAW button 46 is provided to allow the player to effect the draw step of the method of play as desired should the player prefer to use the button panel 40 instead of the DRAW touch screen location 47 on the video screen display 20. A plurality of HOLD buttons 48 are also provided to allow the player to select which cards the player wishes to hold should the player prefer to use the button panel instead of the card touch screen locations on the video screen display 20. If desired, a button may be added to the button panel 40 to allow the player to select the amount to be wagered.

The gaming machine 10 also includes a coin head 50 to allow the player to insert coins or gaming tokens as wagers to allow play of the gaming machine 10. A bill acceptor slot 52 is also provided on the gaming machine 10. In order to accrue credits that may be used to play the gaming machine 10, the player inserts paper currency or other suitable script or gaming coupons into the bill acceptor slot 52 behind which, on the interior of the gaming machine 10, is mounted a bill acceptor which takes in and validates the currency. The monetary value of the inserted currency is then applied to the credit meter 22, the credits on which the player may use to play the gaming machine.

The gaming machine 10 also includes a ticket printer (not shown) of any suitable technology. The ticket printer is mounted on the interior of the gaming machine and the ticket printer slot 70 allows the ticket printer to eject a ticket for accessibility by the player.

The gaming machine 10 is operated by conventional computer controls which are mounted on the interior of the gaming machine. Any other conventional and suitable equipment can be included in the gaming machine 10.

The gaming machine of the present invention can be used for electronic video poker games designed to be played by having a first poker hand representing a first pay line displayed to a player on the video screen 22. By manipulating the buttons on the gaming device or by using conventional touch screen technology, the player selects which cards he wishes to play and which cards he wishes to discard. Replacement cards are then displayed for the discarded cards and the outcome of the play of the hand is determined.

Alternatively, instead of displaying a video poker game, the video screen display 22 can be configured through the computer controls to display one or more lines of symbols so that a video slot machine game may be played on the gaming machine 10. The touch screen locations and the buttons on the button panel are configured in a conventional manner to allow the player to play the gaming machine as a slot machine.

Whenever the player wins a keno ticket or a lottery ticket, the player uses that ticket to participate in either a keno game or a lottery game, respectively.

For example, with regard to the keno ticket, the player could be awarded a keno ticket that has one or more keno numbers that have been selected for the player by the computer controls of the gaming machine 10. The keno ticket would be associated with a particular keno game and the player would win or lose on the keno ticket based on the outcome of the keno numbers selected during the associated keno game.

Preferably, the keno game would be a live keno game conducted on the premises of the same gaming establishment at which the player is playing the electronic gaming machine. When the player achieves a “keno ticket” combination on the gaming machine that the player is playing, the printer would present the keno ticket to the player by dispensing the keno ticket through the printer slot 70 of the gaming machine. The player could participate in the keno game for which the keno ticket is associated by watching the keno game outcome as it is displayed on the keno number boards located throughout the gaming establishment as is conventional. If the player has a winning keno ticket, the player could redeem the winning keno ticket at the cashier's station in the keno lounge or at a suitable casino cage location in the gaming establishment.

Alternatively, when the player wins a keno ticket award, the gaming machine 10 can be configured to provide a location on the video screen display 20 at which the player can select the keno numbers which the player wishes to play on his keno ticket award. For example, a conventional keno layout of eighty numbers can be shown to the player on the video screen display 20 and the player can select one or more numbers to be played on the keno ticket award. The selection of numbers can be done by using touch screen technology or in any other suitable manner. Once the player has selected his numbers, the ticket printer is activated and the keno ticket award is printed and dispensed to the player through ticket printer slot 70.

Alternatively, the player can merely press a touch screen location denominated “Quick Pick” and the computer controls of the gaming machine will randomly select the keno numbers which the player will play on the keno ticket award.

If the video monitor used for the video screen display has sufficient screen area, the live keno game occurring in the gaming establishment can be shown to the player in real time while the player is playing the video gaming machine. The results of one or more of the last live keno games may be displayed to the player. Since keno players often like to see the results of one or more previous games before selecting the keno numbers to be played in the next keno game, this information can be made available to the player to assist in his keno number selection when the player wins a keno ticket award.

Some keno players like to play their “lucky” numbers whenever they play keno. Therefore, it is also possible to configure the gaming machine 10 to allow the player to pick one or more keno numbers to be used on any keno ticket award prior to the player actually winning such an award. In such a configuration, the video screen display for a keno ticket is activated at the time the player begins playing the gaming machine. The player then selects one or more keno numbers which will be used on the keno ticket awarded to the player should the player achieve a combination on the gaming machine that results in the award of a keno ticket. When the player wins such an award, the computer controls of the gaming machine merely print the keno ticket and the player is automatically entered into the next live keno game.

Also, for example, with regard to the lottery ticket, the player could be awarded a lottery ticket that has a group of lottery numbers that have been selected for the player by the computer controls of the gaming machine 10. The lottery ticket would be associated with a particular lottery game and the player would win or lose on the lottery ticket based on the outcome of the lottery numbers selected during the associated lottery game.

Preferably, the lottery game would be one that was conducted either on the premises of the same gaming establishment at which the player is playing the electronic gaming machine or as part of the daily or weekly lottery drawing that is conducted in the state in which the gaming establishment is located. When the player achieves a “lottery ticket” combination on the gaming machine that the player is playing, the printer would present the lottery ticket to the player by dispensing the lottery ticket through the printer slot 70 of the gaming machine. The player could participate in the lottery game for which the lottery ticket is associated by comparing the numbers on the lottery ticket with the lottery numbers drawn during the daily or weekly lottery drawing. If the player has a winning lottery ticket, the player could redeem the winning lottery ticket in the same manner that the player would redeem a winning lottery ticket that the player had purchased directly, rather than having won the lottery ticket playing a gaming machine.

In the embodiment of the present invention in which the player is awarded a lottery ticket instead of a keno ticket, the same various gaming machine configurations may be used. The gaming machine can be configured so that the player can select his lottery numbers, either before he wins a lottery ticket award or at the time the player wins a lottery ticket award. Alternatively, the gaming machine can be configured to allow the player to merely press a “Quick Pick” location and have the gaming machine randomly select the lottery numbers to be used on the lottery ticket awarded to the player.

In another embodiment of the present invention, the ticket printer of the present invention can be used to print award coupons for the player in formats other than keno tickets or lottery tickets. Whenever the player achieves combination of symbols on a slot machine or a combination of playing cards on a video poker game that entitles the player to an award, the computer controls of the gaming machine cause the ticket printer to print an award coupon to the player. The combination of symbols or combination of playing cards can be either a winning or losing combination on the gaming machine.

In one example, whenever the player achieves a Four-of-a-Kind while playing video poker, the player could also win an award coupon dispensed by the ticket printer. The award coupon could be a comp for a free meal, such as a buffet, at the gaming establishment. Or the award coupon could be a prize ticket redeemable for merchandise at a prize booth or in the gift shop of the gaming establishment. The award could a coupon entitling the player to a free or reduced fee entry into a slot tournament or a video poker tournament to be conducted on the premises of the gaming establishment.

Any suitable award scheme could be used as long as the award coupon or ticket can be dispensed by the ticket printer of the gaming machine.

In another alternative embodiment of the present invention, the gaming machine could be configured to have real time access to the world wide web. Each gaming machine in the gaming casino can be provided with an internal modem or a network card so that the gaming machine would have real time access to the world wide web. This access could be by means of a telephone connection or by means of a cable modem connection. Alternatively, the gaming machine could be connected by means of a LAN or a WAN in any suitable conventional manner.

Whenever the player earns a prize award from playing the gaming machine, the player could access a variety of gaming award sites located on the world wide web while the player is still seated at the gaming machine. The gaming casino being visited by the player could have its own prize award redemption site on the world wide web and the redemption site could have a variety of prize awards that are available to the player. The redemption site could have a plurality of pages with each page devoted to various categories of prizes that would appeal to different players. Additionally, the gaming machine could be configured to access world wide sites that are not operated by the gaming casino, but rather have affiliated with the gaming casino to provide prize award redemption services to the gaming casino.

The player can then redeem his prize award from a large group of prizes that can be displayed to the player on the video screen of the gaming machine. Some of the prize awards can be maintained on the premises of the gaming casino and be immediately available to the player. Other prizes can be shipped or sent to the player at his mailing address which would make receipt of the prize very convenient for the player.

Since the video screen display would be right there in front of the player, the review and selection of the prize award could not be more convenient. The player never has to leave his position at the gaming machine and the player can look at the various prize awards that are available in color using the technology of the video screen display. If the prize award comes in sizes, shapes or colors, the player can select the appropriate size, shape or color by merely interacting with the video screen display using either the buttons on the button panel of the gaming machine or by using touch screen technology. The player does not have to worry that the gaming casino may be out of stock of the prize award desired by the player and the entire process of redeeming the player's prize award can be a fun, interactive experience. And there is no waiting for the redemption center to open and there is no standing in line at the redemption center.

In yet another embodiment of the present invention, a person could access either an actual gaming casino or a virtual gaming casino by means of his personal computer. The person would then log on and play video poker on his personal computer. The functions of the ticket printer which has been incorporated into the gaming machine discussed above would be performed by the printer attached to the person's personal computer. When the player achieves a result that entitles him to a bonus award payout, he can use his personal computer to print out an award slip that he can use to redeem his bonus award. Additionally, there are gaming machines now that accept paper coupons as the equivalent of money with the value of the paper coupon being added to the credit meter of the gaming machine so that these credits can be used to play the gaming machine. The player could print out on his personal computer one or more coupons that could then be used in a gaming machine. Appropriate controls by means of bar codes or other security devices would be used to prevent counterfeit coupons from being printed.

If the player had won a keno ticket or a lottery ticket, the player could use his personal computer to print out the keno ticket or the lottery ticket and then the player would take this ticket to a corresponding gaming machine to see if the player had won on this ticket. Again, appropriate controls by means of bar codes or other security devices would be used to prevent counterfeit keno tickets or lottery tickets from being printed. Each participating gaming casino could be outfitted with a ticket reader that would verify the validity of the printed ticket and determine if it was a winning or losing ticket.

While the invention has been illustrated with respect to several specific embodiments thereof, these embodiments should be considered as illustrative rather than limiting. Various modifications and additions may be made and will be apparent to those skilled in the art. Accordingly, the invention should not be limited by the foregoing description, but rather should be defined only by the following claims

What is claimed is:

1. A method of operating a gaming machine having a ticket printer therein comprising:
a) a player participating in a conventional game of chance on the gaming machine; and
b) whenever the player achieves a predetermined arrangement of symbols during the play of the conventional game of chance, by means of the ticket printer awarding the player a prize from the group essentially consisting of a keno ticket, a lottery ticket, a sweepstakes ticket, an entry into a prize contest, and a redeemable coupon.

2. The method of claim 1 in which the gaming machine is a slot machine.

3. The method of claim 2 in which the predetermined arrangement of symbols is three ticket symbols.

4. The method of claim 1 in which the gaming machine is a video poker machine.

5. The method of claim 4 in which the predetermined arrangement of symbols occurs in a final hand for the player.

6. The method of claim 5 in which the final hand is a Royal Flush.

7. The method of claim 4 in which the predetermined arrangement of symbols occurs in a starting hand for a player.

8. The method of claim 7 in which the starting hand is a Ten High hand or lower.
